(19) United States
(12) Patent Application Publication
(10) Pub. No.: US 2006/0015696 A1
(43) Pub. Date: Jan. 19, 2006

(54) Integrated storage device

(76) Inventors: Lu Nguyen, San Jose, CA (US); Doug Dwight Choy, San Jose, CA (US)

Correspondence Address: KONRAD RAYNES & VICTOR, LLP, Suite 210, 315 S. Beverly Drive, Beverly Hills, CA, 90212, US

(21) Appl. No.: 10/892,507

(22) Filed: Jul. 15, 2004

(51) Int. Cl. G06F 12/16

(52) U.S. Cl. 711/162

(57) ABSTRACT

Techniques are provided for creating a backup copy. An instant virtual copy operation is received for copying one or more blocks of data from a source storage to a target storage. For each block of data to be copied from the source storage, a location identifier for the block of data is obtained. The block of data is copied from the source storage to the target storage along with the location identifier. A system having an integrated storage device controller is provided. Disk storage is attached to the integrated storage device controller. One or more tape drives are attached to the integrated storage device controller. A user interface is provided by the integrated storage device controller to enable receipt of commands for direct copying of data between the disk storage and the one or more tape drives.

### BACKGROUND

1. Field

Implementations of the invention relate to an integrated storage device.

2. Description of the Related Art

Computing systems often include one or more host computers (“hosts”) for processing data and running application programs, direct access storage devices (DASDs) for storing data, and a storage controller for controlling the transfer of data between the hosts and the DASD. Storage controllers, also referred to as control units or storage directors, manage access to a storage space comprised of numerous hard disk drives, otherwise referred to as a Direct Access Storage Device (DASD). Hosts may communicate Input/Output (I/O) requests to the storage space through the storage controller.

In many systems, data on one storage device, such as a DASD, may be copied to the same or another storage device so that access to data volumes can be provided from two different devices. A point-in-time copy involves physically copying all the data from source volumes to target volumes so that the target volume has a copy of the data as of a point-in-time. A point-in-time copy can also be made by logically making a copy of the data and then only copying data over when necessary, in effect deferring the physical copying. This logical copy operation is performed to minimize the time during which the target and source volumes are inaccessible.

A number of direct access storage device (DASD) subsystems are capable of performing logical copies, which may be referred to as “instant virtual copy” operations or “copy-on-write” operations. Instant virtual copy operations work by modifying metadata such as relationship tables or pointers to treat a source data object as both the original and copy. In response to a host's copy request, the storage subsystem immediately reports creation of the copy without having made any physical copy of the data. Only a “virtual” copy has been created, and the absence of an additional physical copy is completely unknown to the host.

Later, when the storage system receives updates to the original or copy, the updates are stored separately and cross-referenced to the updated data object only. At this point, the original and copy data objects begin to diverge. The initial benefit is that the instant virtual copy occurs almost instantaneously, completing much faster than a normal physical copy operation. This frees the host and storage subsystem to perform other tasks. The host or storage subsystem may even proceed to create an actual, physical copy of the original data object during background processing, or at another time.

One such instant virtual copy operation is known as a FlashCopy® operation. A FlashCopy® operation involves establishing a logical point-in-time relationship between source and target volumes on the same or different devices. The FlashCopy® operation guarantees that until a track in a FlashCopy® relationship has been hardened to its location on the target disk, the track resides on the source disk. A relationship table is used to maintain information on all existing FlashCopy® relationships in the subsystem. During the establish phase of a FlashCopy® relationship, one entry is recorded in the source and target relationship tables for the source and target that participate in the FlashCopy® relationship being established. Each added entry maintains all the required information concerning the FlashCopy® relationship. Both entries for the relationship are removed from the relationship tables when all FlashCopy® tracks from the source volumes have been physically copied to the target volumes or when a withdraw command is received. In certain cases, even though all tracks have been copied from the source volumes to the target volumes, the relationship persists.

The target relationship table further includes a bitmap that identifies which tracks involved in the FlashCopy® relationship have not yet been copied over and are thus protected tracks. Each track in the target device is represented by one bit in the bitmap. The target bit is set when the corresponding track is established as a target track of a FlashCopy® relationship. The target bit is reset when the corresponding track has been copied from the source and destaged to the target due to writes on the source or the target, or a background copy task.

Further details of the FlashCopy® operations are described in the copending and commonly assigned U.S. Pat. No. 6,661,901, issued on Aug. 26, 2003, entitled “Method, System, and Program for Maintaining Electronic Data as of a Point-in-Time”, which patent application is incorporated herein by reference in its entirety.

Once the logical relationship is established, hosts may then have immediate access to data on the source and target volumes, and the data may be copied as part of a background operation. A read to a track that is a target in a FlashCopy® relationship and not in cache triggers a stage intercept, which causes the source track corresponding to the requested target track to be staged to the target cache when the source track has not yet been copied over and before access is provided to the track from the target cache. This ensures that the target has the copy from the source that existed at the point-in-time of the FlashCopy® operation. Further, any destages to tracks on the source device that have not been copied over triggers a destage intercept, which causes the tracks on the source device to be copied to the target device.

Currently, system administrators spend a great deal of time creating backup copies of data. The current process for creating a backup copy of a database has multiple tasks. Initially, the database is mapped to source volumes (i.e., the source volumes on which the database resides are identified). For each source volume, an appropriate target volume is selected based on factors, such as the size and type of the source volume. An instant virtual copy operation is performed between the source volumes and the target volumes, which consumes an equal amount of storage space (e.g., to create a point-in-time copy of one terabyte of data requires an extra terabyte of storage space). The target volumes are assigned to the first host that requested the instant virtual copy operation (which may affect the performance of the host) or to a second host of the same type as the first host. The selected host to which the target volumes are assigned is notified about the target volumes. Optionally, the database may be made available on another host. Then, a backup/archive process at the selected host is used to read the data from the target volumes and copy the data to a third computer system, such as a backup server. If tapes are not already mounted to tape drives attached to the backup server, these are mounted. The backup server writes the data to the tapes. Then, the tapes contain a backup copy of the database. This process of creating a backup copy of the database uses up to two times the storage space of the database, up to three computer systems, and backup software. Furthermore, because of the complexity of the process, system administrators may spend a great deal of time (e.g., more than half of their time) creating backup copies. For large amounts of data, the process may also strain fibre channel and Ethernet networks because of the data movement between the three computing systems. Backup servers may also be strained by having to write large amounts of data to tape.

In U.S. Pat. No. 6,625,704 B2, issued on Sep. 23, 2003, to Alexander Winokur, and entitled “Data Backup Method and System Using Snapshot and Virtual Tape,” information identifying a set of data that is to be copied from a first DASD is received and destination locations are mapped in a second DASD for each element of the set. The destination locations are in a sequence emulating a tape copy.

Notwithstanding the usefulness of conventional systems, there is a need in the art for an integrated storage device that allows simpler creation of backup copies.

### SUMMARY OF THE INVENTION

Provided are an article of manufacture, system, and method for creating a backup copy. An instant virtual copy operation is received for copying one or more blocks of data from a source storage to a target storage. For each block of data to be copied from the source storage, a location identifier for the block of data is obtained. The block of data is copied from the source storage to the target storage along with the location identifier.

Also, provided is a system including an integrated storage device controller. Disk storage is attached to the integrated storage device controller. One or more tape drives are attached to the integrated storage device controller. A user interface is provided by the integrated storage device controller to enable receipt of commands for direct copying of data between the disk storage and the one or more tape drives.

### BRIEF DESCRIPTION OF THE DRAWINGS

Referring now to the drawings in which like reference numbers represent corresponding parts throughout:

FIG. 1 illustrates a computing environment in which certain implementations of the invention are implemented.

FIG. 2 illustrates blocks of storage in accordance with certain implementations of the invention.

FIG. 3 illustrates various structures in accordance with certain implementations of the invention.

FIGS. 4A and 4B illustrate logic for creating a backup copy of data in accordance with certain implementations of the invention.

FIG. 5 illustrates logic for restoring data from target storage to source storage in accordance with certain implementations of the invention.

FIG. 6 illustrates an architecture of a computer system that may be used in accordance with certain implementations of the invention.

### DETAILED DESCRIPTION OF THE IMPLEMENTATIONS

In the following description, reference is made to the accompanying drawings which form a part hereof and which illustrate several implementations of the invention. It is understood that other implementations may be utilized and structural and operational changes may be made without departing from the scope of implementations of the invention.

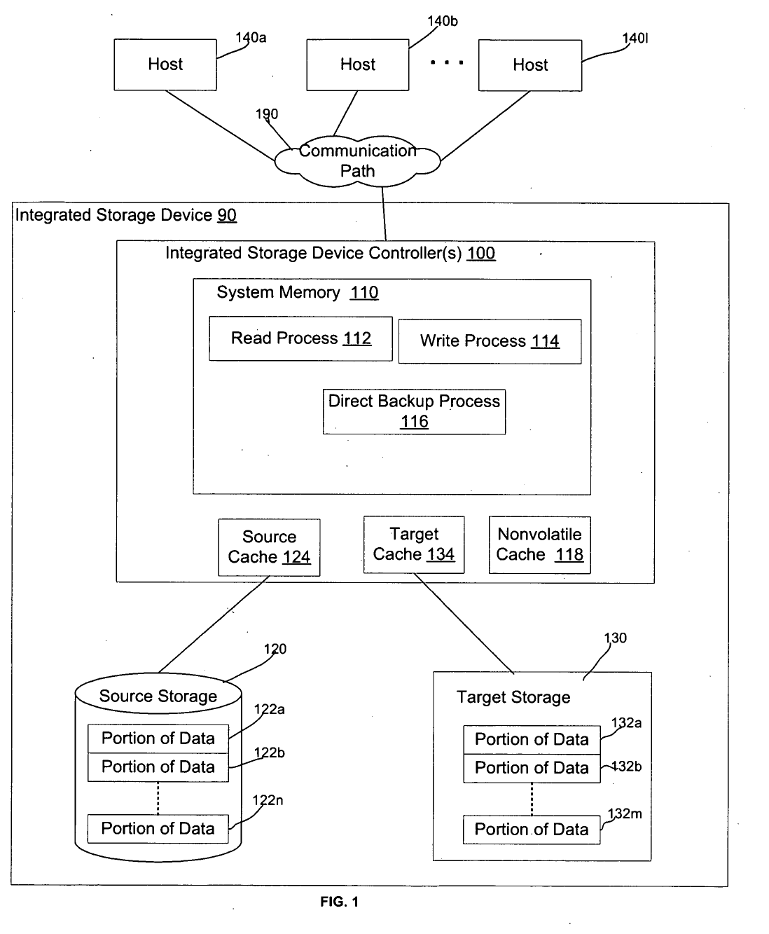

FIG. 1 illustrates, in a block diagram, a computing environment in accordance with certain implementations of the invention. An integrated storage device 90 includes one or more integrated storage device controllers 100, source storage 120, and target storage 130.

An integrated storage device controller 100 receives Input/Output (I/O) requests from hosts 140a, b, . . . l (wherein a, b, and l may be any integer value) over a communication path 190 directed toward storage devices 120, 130 configured to have portions of data (e.g., Logical Unit Numbers, Logical Devices, portions of tapes mounted in tape drives, etc.) 122a, b, . . . n and 132a, b, . . . m, respectively, where m and n may be different integer values or the same integer value. The communication path may comprise, for example, a bus or a storage area network. Thus, the hosts 140a, b, . . . l may be directly attached to the integrated storage device 90 or may be connected via a storage area network to the integrated storage device 90.

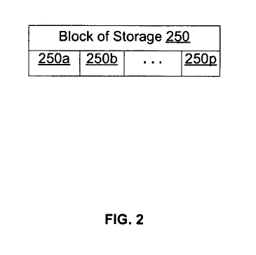

FIG. 2 illustrates a block of storage in accordance with certain implementations of the invention. A block of storage 250 may be divided into sub-blocks of storage 250a, 250b . . . 250p, where a, b, and p represent that there may be any number of sub-blocks of storage.

The source storage 120 includes one or more portions of data 122a, b, . . . n, which may be divided into blocks of storage 250 containing blocks of data, and the blocks of storage 250 are further divided into sub-blocks of storage (250a, 250b . . . 250p) that contain sub-blocks of data. A portion of data may be any logical or physical element of storage. In certain implementations, the blocks of data are contents of tracks, while the sub-blocks of data are contents of sectors of tracks.

In certain implementations, target storage 130 may comprise any form of removable storage that stores data sequentially (e.g., tapes mounted on tape drives). Storage that stores data sequentially stores data in a next available consecutive portion of storage, rather than storing data randomly in the storage. That is, target storage 130 may comprise one or more sequential access storage devices. Sequential access storage devices read or write data in consecutive portions of storage or may incur a performance penalty (e.g., to rewind or forward a tape to a particular portion of storage) to read or write at non-consecutive portions of storage, whereas random access storage devices read and write from any portion of storage.

Target storage 130 maintains copies of all or a subset of the portions of data 122a, b, . . . n of the source storage 120. Additionally, target storage 130 may be modified by, for example, host 140a. Target storage 130 includes one or more portions of data 132a, b . . . m, which may be divided into blocks of storage 250 containing blocks of data, and the blocks of storage 250 are further divided into sub-blocks of storage (250a, 250b . . . 250p) that contain sub-blocks of data. A portion of data may be any logical or physical element of storage. In certain implementations, the blocks of data are tracks, while the sub-blocks of data are sectors of tracks.

For ease of reference, the terms tracks and sectors will be used herein as examples of blocks of data and sub-blocks of data, but use of these terms is not meant to limit implementations of the invention to tracks and sectors. The implementations of the invention are applicable to any type of storage, block of storage or block of data divided in any manner. Moreover, although implementations of the invention refer to blocks of data, alternate implementations of the invention are applicable to sub-blocks of data.

In certain implementations, the source storage 120 is a disk device, and the target storage 130 is a tape device. Thus, certain implementations of the invention provide an integrated disk and tape device. In certain implementations, the source storage 120 may comprise an array of storage devices, such as Just a Bunch of Disks (JBOD), Redundant Array of Independent Disks (RAID), a virtualization device, etc. In certain implementations, the tape device is an automated tape library, containing one or more tape drives, storage for a large number of tapes, and a robotic arm to automatically mount and unmount tapes into the tape drives from the tape library. In certain implementations, the integrated storage device 90 comprises one or more storage controllers, attached via high speed links (e.g., Fibre Channel links) to the disk device and tape device.

The integrated storage device controller 100 includes a source cache 124 in which updates to tracks in the source storage 120 are maintained until written to source storage 120 (i.e., the tracks are destaged to physical storage). The integrated storage device controller 100 includes a target cache 134 in which updates to tracks in the target storage 130 are maintained until written to target storage 130 (i.e., the tracks are destaged to physical storage). The source cache 124 and target cache 134 may comprise separate memory devices or different sections of a same memory device. The source cache 124 and target cache 134 are used to buffer read and write data being transmitted between the hosts 140a, b, . . . l, source storage 120, and target storage 130. Further, although caches 124 and 134 are referred to as source and target caches, respectively, for holding source or target blocks of data in a point-in-time copy relationship, the caches 124 and 134 may store at the same time source and target blocks of data in different point-in-time relationships.

Additionally, the integrated storage device controller 100 includes a nonvolatile cache 118. The non-volatile cache 118 may be, for example, a battery-backed up volatile memory, to maintain a non-volatile copy of data updates.

The integrated storage device controller 100 further includes system memory 110, which may be implemented in volatile and/or non-volatile devices. The system memory 110 includes a read process 112 for reading data, a write process 114 for writing data, and a direct backup process 116. The read process 112 executes in system memory 110 to read data from storages 120 and 130 to caches 124 and 134, respectively. The write process 114 executes in system memory 110 to write data from caches 124 and 134 to storages 120 and 130, respectively. The direct backup process 116 executes in system memory 110 to create a backup copy of data from all or a portion of source storage 120 to target storage 130.

In certain implementations, the integrated storage device 90 contains two or more storage controllers, a disk device, and a tape device. The direct backup process 116 may span the storage controllers, may execute on each storage controller or may execute within the single integrated storage device 90.

Also, the system memory 110 may be in a separate memory device from caches 124 and 134 or may share a memory device with one or both caches 124 and 134.

Implementations of the invention are applicable to the transfer of data between any two storage mediums, which for ease of reference will be referred to herein as source storage and target storage or as first storage and second storage. For example, certain implementations of the invention may be used with two storage mediums located at a single storage controller. Moreover, certain alternative implementations of the invention may be used with two storage mediums connected to different storage controllers. Also, for ease of reference, a block of data in source storage will be referred to as a “source block of data,” and a block of data in target storage will be referred to as a “target block of data.”

In certain implementations, the integrated storage device controller 100 comprises a storage controller, which may further include a processor complex (not shown) and may comprise any storage controller or server known in the art, such as an Enterprise Storage Server® (ESS), 3990®Storage Controller, etc. The hosts 140a, b, . . . l may comprise any computing device known in the art, such as a server, mainframe, workstatation, personal computer, hand held computer, laptop telephony device, network appliance, etc.

The integrated storage device controller 100 and host system(s) 140a, b, . . . l communicate via a communication path 190, which may comprise a network (e.g., a Storage Area Network (SAN), a Local Area Network (LAN), Wide Area Network (WAN), the Internet, an Intranet, etc.) or a direct attachment technology (e.g., Small Computer System Interface (SCSI) or Serial ATA).

Additionally, although FIG. 1 illustrates a single integrated storage device 90, one skilled in the art would know that multiple integrated storage devices may be connected via a network (e.g., a Local Area Network (LAN), Wide Area Network (WAN), the Internet, etc.), and one or more of the multiple integrated storage devices may implement the invention.

Hosts 140a, b, . . . l attach to the integrated storage device controller 100 and use the integrated storage device controller 100 like a storage controller. The integrated storage device controller 100, however, is capable of creating a backup copy from source storage 120 directly to target storage 130 that comprises removable storage that stores data sequentially.

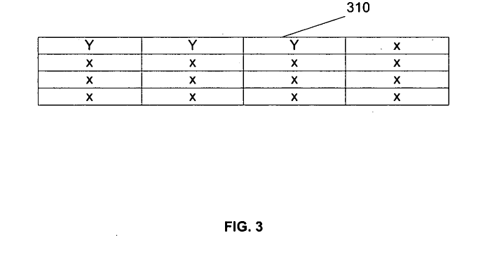

FIG. 3 illustrates a copy structure 310 in accordance with certain implementations of the invention. Copy structure 310 may be stored in nonvolatile cache 118 or in system memory 110 of the integrated storage device controller 100. A copy structure 310 is used to monitor which blocks of data within portions of data in the source storage 120 have been copied to target storage 130. The copy structure 310 includes an indicator (e.g., a bit) for each block of data in the source storage 120 that is part of the incremental virtual copy relationship. When an indicator is set to a first value (e.g., one), the setting indicates that the block of data has been copied to target storage 130. When an indicator is set to a second value (e.g., zero), the setting indicates that the block of data has not been copied to target storage 130. For example, in copy structure 310, the indicators of “X” indicate that blocks of data associated with the X indicators have been copied to storage, while indicators of “Y” indicate that blocks of data associated with the Y indicators have not been copied to storage.

In certain implementations of the invention, copy structure 310 comprises a bitmap, and each indicator comprises a bit. In certain implementations, for copy structure 310, the nth indicator corresponds to an nth block of data (e.g., the first indicator in structure 310 corresponds to a first block of data). In certain implementations of the invention, there is a copy structure 310 for each portion of data. In certain alternative implementations of the invention, there is a single copy structure 310 for all portions of data at source storage 120.

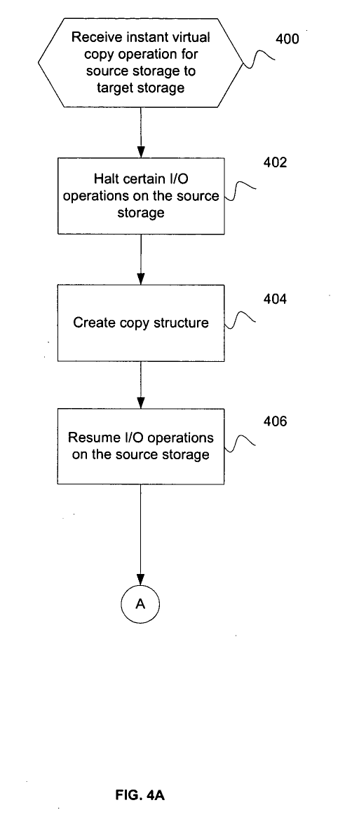

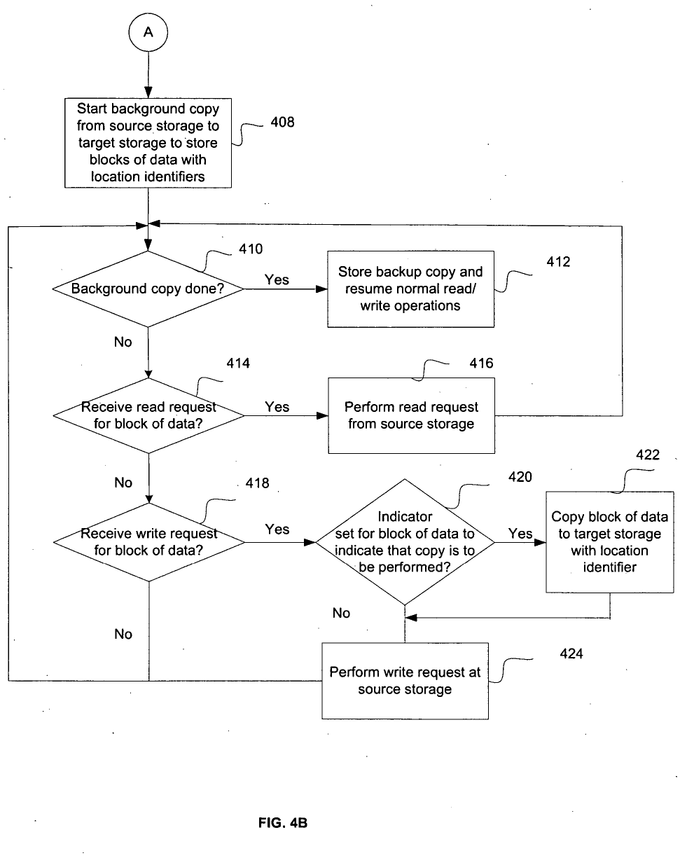

FIGS. 4A and 4B illustrate logic for creating a backup copy of data in accordance with certain implementations of the invention. Control begins at block 400 with the direct backup process 116 receiving an instant virtual copy operation for creating a backup copy of data at source storage 120 to target storage 130. In certain implementations, users and/or application programs may invoke the instant virtual copy operation. In certain implementations, a user interface (e.g., a graphical user interface) is provided by implementations of the invention to enable scheduling of backup copies. For example, periodically (e.g., every night), the integrated storage device controller 100 halts certain Input/Output (I/O) operations to the source storage 120 and performs the instant virtual copy operation to store data from source storage 120 to target storage 130, which is removable storage that stores data sequentially. In certain implementations, both read operations and write operations are halted. In certain other implementations, write operations are suspended and read operations are allowed to continue. The removable storage may then be removed and, for example, sent by a system administrator for offsite storage.

In block 402, the direct backup process 116 halts certain I/O operations (e.g., read and write operations or only write operations) on the source storage 120. In block 404, the direct backup process 116 creates copy structure 310. In particular, all of the indicators in the copy structure 310 are set to indicate that the blocks of data associated with the indicators are to be copied to target storage. In certain implementations, the copy structure 310 has already been created, and the processing of block 404 updates the copy structure 310. In block 406, the direct backup process 116 resumes I/O operations on the source storage 120.

From block 406 (FIG. 4A), processing continues to block 408 (FIG. 4B). In block 408, the direct backup process 116 starts a background copy from source storage to target storage to store blocks of data with location identifiers. The location identifiers identify the location of the block of data in source storage 120 relative to other blocks of data. In certain implementations, the location identifiers are sequence identifiers. In certain implementations, the location identifiers are offsets from a base position in source storage 120. In certain implementations, the location identifier is generated for a block of data when that block of data is to be copied to target storage 130. In certain implementations, the location identifiers are generated and stored with the blocks of data on source storage 120, and when a block of data is copied to target storage 130, the block of data is copied along with its location identifier. In certain implementations, the location identifier is 64-bits.

In block 410, the direct backup process 116 determines whether the background copy is done. If so, processing continues to block 412, otherwise, processing continues to block 414. In block 412, the backup copy on removable storage may be stored (e.g., offsite or in a tape library) and normal read/write operations resume. In particular, read and write operations continue to occur during the background operation, but they are not handled in a “normal” manner, instead they are handled as described with reference to blocks 414-424.

For example, if the target storage 130 is a tape library with a set of one or more tape drives for holding tapes, a tape may be ejected from a tape drive for storage in the tape library. Alternatively, a tape may be left in a tape drive and may be ejected as needed (e.g., when a new backup copy is to be made onto another set of one or more tapes). In some cases, a system administrator may also make a copy of a tape and send the tape off site for secure storage.

In block 414, the direct backup process 116 determines whether a read request for a block of data has been received. If so, processing continues to block 416, otherwise, processing continues to block 418. In block 416, the read request is performed from source storage. From block 416, processing loops back to block 410.

In block 418, the direct backup process 116 determines whether a write request for a block of data has been received. If so, processing continues to block 420, otherwise, processing loops back to block 410. In block 420, the direct backup process 116 determines whether an indicator is set for the block of data to indicate that the block of data still needs to be copied from source storage 120 to target storage 130. If so, processing continues to block 422, otherwise, processing continues to block 424. In block 422, the direct backup process 116 copies the block of data to target storage 130 with a location identifier and processing continues to block 424. In block 424, the write request is performed at source storage 120.

It is possible that when a write request for a block of data is received, the background copy has not copied one or more blocks of data sequentially prior to the block of data to be written. For example, for blocks of data with sequence numbers 100, 101, 102, 103, and 104, it is possible that blocks of data with sequence numbers 100 and 101 have been copied from source storage 120 to target storage 130, a write request is received for block of data with sequence number 104, and blocks of data with sequence numbers 102 and 103 have not been copied from source storage 120 to target storage 130. In this case, to avoid holding up the write request, the direct backup process 116 copies the data block with sequence number 104 from source storage 120 to target storage 130, along with a location identifier that indicates the location of the block of data with sequence number 104 with respect to other blocks of data at source storage 120 that are part of the instant virtual copy relationship. Then, the backup copy continues and, in this example, blocks of data with sequence numbers 102 and 103 are copied to target storage 130. Note that each block of data copied to target storage 130 is stored with a location identifier. The location identifiers are used because the target storage 130 stores data in sequential positions in storage (rather than in random positions, which would allow for allocating space for blocks of data with sequence numbers 102 and 103 when writing block of data with sequence number 104 from the above example).

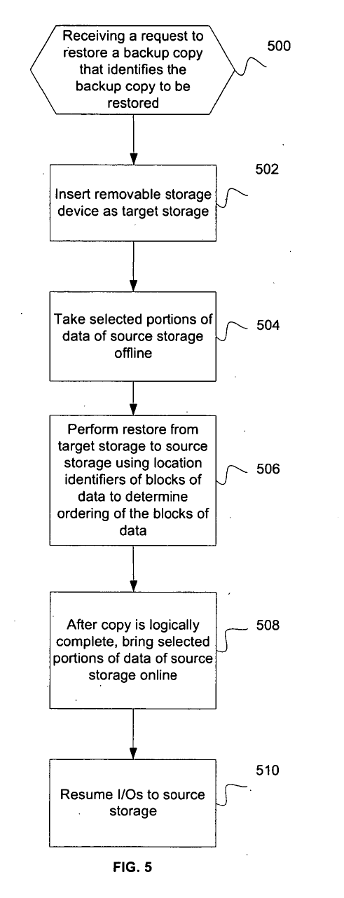

When data is to be restored from target storage 130 to source storage 120, the location identifiers are used to order the blocks of data. FIG. 5 illustrates logic for restoring data from target storage to source storage in accordance with certain implementations of the invention. Control begins at block 500 with receipt of a request to restore a backup copy that identifies the backup copy to be restored. Each backup copy may be stored at target storage 130 with an identifier, such as a timestamp, a user or system administrator provided name, etc. Additionally, each backup copy identifies the portions of data (e.g., volumes) of source storage 120 that were copied to target storage 130. Then, a user or system administrator may specify which backup copy to restore using, for example, a user interface provided by implementations of the invention.

In block 502, one or more removable storages are loaded at the integrated storage device controller 100. For example, the removable storages may be one or more tapes that are mounted on tape drives of a tape library attached to the integrated storage device controller 100.

In certain implementations, when target storage 130 is a tape library, a system administrator may issue the command to restore a certain backup copy. In response to that command, the integrated storage device controller 100 automatically selects the correct tape from the tape library that stores the certain backup copy and mounts the tape into a tape drive.

In block 504, the direct backup process 116 takes selected portions of data (e.g., volumes) of source storage 120 offline. The selected portions of data correspond to portions of data to be restored with the backup copy on target storage 130.

In block 506, the direct backup process 116 performs the restore from the target storage 130 to source storage 120 using the location identifiers of blocks of data to determine the ordering of the blocks of data on source storage 120. Performing the restore comprises copying blocks of data from target storage 130 to source storage 120. In certain implementations in which the target storage 130 is a tape library and source storage 120 is a disk device, the restore is performed by reading a block of data sequentially from a tape and writing the data to the disk device in its correct location using the location identifier. In some implementations, the direct backup process 116 may read several blocks of data from tape and sort them before writing the blocks of data to the disk device.

In certain implementations, target storage 130 is a first target storage 130 and there is a second target storage (not shown in FIG. 1), which resides on random access storage. The processing of block 506 is performed to restore blocks of data from the first target storage 130 to the second target storage. Then, certain I/O operations (e.g., read and write operations or only write operations) are halted on source storage 120, and an instant virtual copy (e.g., FlashCopy® operation) is performed from the second target storage to the source storage 120. In block 508, after the copy is logically complete, the direct backup process 116 brings the selected portions of data of source storage 120 online. In block 510, I/Os are resumed to source storage 120.

In certain alternative implementations, a process other than the direct backup process 116 (e.g., a direct restore process that resides in system memory 110 (not shown)) may perform the processing of blocks 504, 506, and 508.

Example scenarios will be provided merely to enhance understanding of the invention. In one example scenario, the source storage 120 is a disk device and the target storage 130 is a tape library. To create a backup copy, blocks of data are copied directly from the disk device to a tape via an instant virtual copy operation. Then, to restore the backup copy on tape, blocks of data are copied directly from the tape to the disk device.

In another example scenario, it is possible to create an instant virtual copy from Storage A to Storage B, create an instant virtual copy from Storage B to tape, and eject the tape for off-site storage once a background copy from Storage B is complete. Then, at restore time, if Storage B contains a good copy of data, an instant virtual copy from Storage B to Storage A may be performed. However, if data at Storage B is corrupt or if an older version of a backup copy is to be restored from tape, the tape may be inserted at the integrated storage device controller 100, data may be copied from tape to Storage B, and then the data may be copied from Storage B to Storage A via an instant virtual copy operation.

Thus, implementations of the invention eliminate the need for multiple computing systems and complex backup software. Also, implementations of the invention eliminate the need for target disk space by copying data from source storage 120 to tape in random order, along with a location identifier that allows data to be restored to its proper location on source storage 120.

For example, assuming 512-byte blocks and an 8-byte location identifier, it is expected that there would be a 1.5% overhead for creating backup copies, whereas conventional solutions have as much as a 100% overhead. Additionally, in certain implementations, four or more tape drives are used to stripe data for better performance. Assuming that IBM® 3592 Enterprise tape drives are used with 2:1 compaction, four tape drives provide 320 megabytes/second of throughput, which is faster than most disk to disk instant virtual copies.

IBM is a registered trademark or common law mark of International Business Machines Corporation in the United States and/or foreign countries.

### Additional Implementation Details

The described implementations may be implemented as a method, apparatus or article of manufacture using programming and/or engineering techniques to produce software, firmware, hardware, or any combination thereof. The terms “article of manufacture” and “circuitry” as used herein refer to a state machine, code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. When the code or logic is executed by a processor, the circuitry may include the medium including the code or logic as well as the processor that executes the code loaded from the medium. The code in which embodiments are implemented may further be accessible through a transmission media or from a server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration, and that the article of manufacture may comprise any information bearing medium known in the art.

The logic of FIGS. 4A, 4B, and 5 describes specific operations occurring in a particular order. In alternative implementations, certain of the logic operations may be performed in a different order, modified or removed. Moreover, operations may be added to the above described logic and still conform to the described implementations. Further, operations described herein may occur sequentially or certain operations may be processed in parallel, or operations described as performed by a single process may be performed by distributed processes.

The illustrated logic of FIGS. 4A, 4B, and 5 may be implemented in software, hardware, programmable and non-programmable gate array logic or in some combination of hardware, software, or gate array logic.

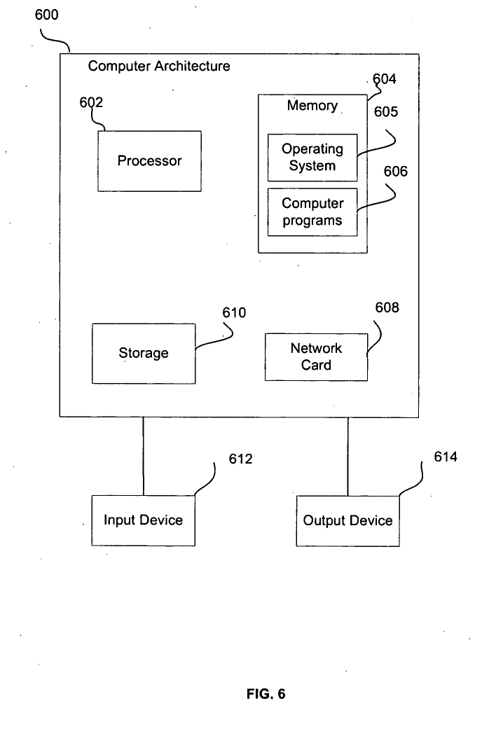

FIG. 6 illustrates an architecture 600 of a computer system that may be used in accordance with certain implementations of the invention. Integrated storage device controller 100 and/or hosts 140a, b, . . . l may implement computer architecture 600. The computer architecture 600 may implement a processor 602 (e.g., a microprocessor), a memory 604 (e.g., a volatile memory device), and storage 610 (e.g., a non-volatile storage area, such as magnetic disk drives, optical disk drives, a tape drive, etc.). An operating system 605 may execute in memory 604. The storage 610 may comprise an internal storage device or an attached or network accessible storage. Computer programs 606 in storage 610 may be loaded into the memory 604 and executed by the processor 602 in a manner known in the art. The architecture further includes a network card 608 to enable communication with a network. An input device 612 is used to provide user input to the processor 602, and may include a keyboard, mouse, pen-stylus, microphone, touch sensitive display screen, or any other activation or input mechanism known in the art. An output device 614 is capable of rendering information from the processor 602, or other component, such as a display monitor, printer, storage, etc. The computer architecture 600 of the computer systems may include fewer components than illustrated, additional components not illustrated herein, or some combination of the components illustrated and additional components.

The computer architecture 600 may comprise any computing device known in the art, such as a mainframe, server, personal computer, workstation, laptop, handheld computer, telephony device, network appliance, virtualization device, storage controller, etc. Any processor 602 and operating system 605 known in the art may be used.

The foregoing description of implementations of the invention has been presented for the purposes of illustration and description. It is not intended to be exhaustive or to limit the implementations of the invention to the precise form disclosed. Many modifications and variations are possible in light of the above teaching. It is intended that the scope of the implementations of the invention be limited not by this detailed description, but rather by the claims appended hereto. The above specification, examples and data provide a complete description of the manufacture and use of the composition of the implementations of the invention. Since many implementations of the invention can be made without departing from the spirit and scope of the implementations of the invention, the implementations of the invention reside in the claims hereinafter appended or any subsequently-filed claims, and their equivalents.

What is claimed is:

1. An article of manufacture including program logic for creating a backup copy, wherein the program logic causes operations to be performed, the operations comprising:
receiving an instant virtual copy operation for copying one or more blocks of data from a source storage to a target storage; and
for each block of data to be copied from the source storage,
obtaining a location identifier for the block of data; and
copying the block of data from the source storage to the target storage along with the location identifier.

2. The article of manufacture of claim 1, wherein the target storage comprises removable storage that stores data sequentially.

3. The article of manufacture of claim 1, wherein the operations for obtaining the location identifier further comprise:
obtaining the location identifier from the source storage, wherein the location identifier is stored on the source storage with the block of data.

4. The article of manufacture of claim 1, wherein the operations for obtaining the location identifier further comprise:
generating the location identifier when copying the block of data to the target storage.

5. The article of manufacture of claim 1, wherein the operations further comprise:
halting certain Input/Output (I/O) operations on the source storage;
creating a copy structure to indicate which blocks of data are to be copied from the source storage to the target storage; and
resuming the I/O operations on the source storage.

6. The article of manufacture of claim 1, wherein the blocks of data are copied from the source storage to the target storage using a background copy operation and wherein the operations further comprise:
storing the backup copy of the blocks of data and resuming normal read/write operations in response to determining that the background copy is done.

7. The article of manufacture of claim 1, wherein the operations further comprise:
receiving a read request for a block of data on source storage; and
performing the read request from source storage.

8. The article of manufacture of claim 1, wherein the operations further comprise:
receiving a write request for a block of data on source storage;
determining whether the block of data has already been copied to the target storage;
in response to determining that the block of data has been copied to the target storage, performing the write request at the source storage; and
in response to determining that the block of data has not been copied to the target storage,
copying the block of data to the target storage with the location identifier; and
performing the write request at the source storage.

9. The article of manufacture of claim 1, wherein the operations further comprise:
receiving a request to restore one or more blocks of data from the target storage to the source storage;
copying the one or more blocks of data from the target storage to the source storage using the location identifier associated with each block of data to determine the order of the blocks of data in the source storage.

10. The article of manufacture of claim 1, wherein the target storage is a first target storage and wherein the operations further comprise:
receiving a request to restore one or more blocks of data from the first target storage to a source storage;
copying the one or more blocks of data from the first target storage to a second target storage using the location identifier associated with each block of data to determine the order of the blocks of data in the second target storage; and
performing an instant virtual copy operation to copy the one or more blocks of data from the second target storage to the source storage.

11. A system comprising:
an integrated storage device controller;
disk storage attached to the integrated storage device controller;
one or more tape drives attached to the integrated storage device controller; and
a user interface provided by the integrated storage device controller to enable receipt of commands for direct copying of data between the disk storage and the one or more tape drives.

12. The system of claim 11, wherein the integrated storage device controller comprises a storage controller attached via high speed links to the disk storage and the one or more tape drives.

13. The system of claim 12, wherein the high speed links comprise Fibre Channel links.

14. The system of claim 11, further comprising:
means for receiving at the integrated storage device controller an instant virtual copy operation for copying one or more blocks of data from the disk storage to one or more tapes mounted on the one or more tape drives; and
for each block of data to be copied from the disk storage,
means for obtaining a location identifier for the block of data; and
means for copying the block of data from the disk storage to the one or more tapes along with the location identifier.

15. A system for creating a backup copy, comprising:
circuitry capable of causing operations to be performed, the operations comprising:
receiving an instant virtual copy operation for copying one or more blocks of data from a source storage to a target storage; and
for each block of data to be copied from the source storage,
obtaining a location identifier for the block of data; and
copying the block of data from the source storage to the target storage along with the location identifier.

16. The system of claim 15, wherein the target storage comprises removable storage that stores data sequentially.

17. The system of claim 15, wherein the operations for obtaining the location identifier further comprise:
obtaining the location identifier from the source storage, wherein the location identifier is stored on the source storage with the block of data.

18. The system of claim 15, wherein the operations for obtaining the location identifier further comprise:
generating the location identifier when copying the block of data to the target storage.

19. The system of claim 15, wherein the operations further comprise:
halting certain Input/Output (I/O) operations on the source storage;
creating a copy structure to indicate which blocks of data are to be copied from the source storage to the target storage; and
resuming the I/O operations on the source storage.

20. The system of claim 15, wherein the blocks of data are copied from the source storage to the target storage using a background copy operation and wherein the operations further comprise:
storing the backup copy of the blocks of data and resuming normal read/write operations in response to determining that the background copy is done.

21. The system of claim 15, wherein the operations further comprise:
receiving a read request for a block of data on source storage; and
performing the read request from source storage.

22. The system of claim 15, wherein the operations further comprise:
receiving a write request for a block of data on source storage;
determining whether the block of data has already been copied to the target storage;
in response to determining that the block of data has been copied to the target storage, performing the write request at the source storage; and
in response to determining that the block of data has not been copied to the target storage,
copying the block of data to the target storage with the location identifier; and
performing the write request at the source storage.

23. The system of claim 15, wherein the operations further comprise:
receiving a request to restore one or more blocks of data from the target storage to the source storage;
copying the one or more blocks of data from the target storage to the source storage using the location identifier associated with each block of data to determine the order of the blocks of data in the source storage.

24. The system of claim 15, wherein the target storage is a first target storage and wherein the operations further comprise:
receiving a request to restore one or more blocks of data from the first target storage to a source storage;
copying the one or more blocks of data from the first target storage to a second target storage using the location identifier associated with each block of data to determine the order of the blocks of data in the second target storage; and
performing an instant virtual copy operation to copy the one or more blocks of data from the second target storage to the source storage.

25. A method for creating a backup copy, comprising:
receiving an instant virtual copy operation for copying one or more blocks of data from a source storage to a target storage; and
for each block of data to be copied from the source storage,
obtaining a location identifier for the block of data; and
copying the block of data from the source storage to the target storage along with the location identifier.

26. The method of claim 25, wherein the target storage comprises removable storage that stores data sequentially.

27. The method of claim 25, wherein the obtaining the location identifier further comprises:
obtaining the location identifier from the source storage, wherein the location identifier is stored on the source storage with the block of data.

28. The method of claim 25, wherein obtaining the location identifier further comprises:
generating the location identifier when copying the block of data to the target storage.

29. The method of claim 25, further comprising:
halting certain Input/Output (I/O) operations on the source storage;
creating a copy structure to indicate which blocks of data are to be copied from the source storage to the target storage; and
resuming the I/O operations on the source storage.

30. The method of claim 25, wherein the blocks of data are copied from the source storage to the target storage using a background copy operation and further comprising:
storing the backup copy of the blocks of data and resuming normal read/write operations in response to determining that the background copy is done.

31. The method of claim 25, further comprising:
receiving a read request for a block of data on source storage; and
performing the read request from source storage.

32. The method of claim 25, further comprising:
receiving a write request for a block of data on source storage;
determining whether the block of data has already been copied to the target storage;
in response to determining that the block of data has been copied to the target storage, performing the write request at the source storage; and
in response to determining that the block of data has not been copied to the target storage,
copying the block of data to the target storage with the location identifier; and
performing the write request at the source storage.

33. The method of claim 25, further comprising:
receiving a request to restore one or more blocks of data from the target storage to the source storage;
copying the one or more blocks of data from the target storage to the source storage using the location identifier associated with each block of data to determine the order of the blocks of data in the source storage.

34. The method of claim 25, wherein the target storage is a first target storage and further comprising:
receiving a request to restore one or more blocks of data from the first target storage to a source storage;
copying the one or more blocks of data from the first target storage to a second target storage using the location identifier associated with each block of data to determine the order of the blocks of data in the second target storage; and
performing an instant virtual copy operation to copy the one or more blocks of data from the second target storage to the source storage.
